(19) United States
(12) Patent Application Publication
(10) Pub. No.: US 2005/0139683 A1
(43) Pub. Date: Jun. 30, 2005

(54) Communication terminal equipped with a replaceable cover and method of changing themes of communication terminal using the same

(75) Inventor: Ki Won Yi, Incheon-Metropolitan city (KR)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: CURITEL COMMUNICATIONS, INC.

(21) Appl. No.: 11/020,623

(22) Filed: Dec. 23, 2004

(30) Foreign Application Priority Data
Dec. 26, 2003 (KR) 10-2003-0097362

(51) Int. Cl. G06K 7/00

(52) U.S. Cl. 235/486

(57) ABSTRACT

Disclosed are a communication terminal equipped with a replaceable cover and a method of changing themes of the communication terminal using the same. The replaceable cover according to an embodiment of the present invention comprises: a cover body; and a memory card, fixed to an inner surface of the cover body, for providing display registration information to the communication terminal, wherein the memory card is directly connected to a connector of the communication terminal when the cover is mounted to the communication terminal, and wherein themes of the communication terminal can be changed by replacing the cover according to the display registration information provided by the memory card.

### CROSS-REFERENCE TO RELATED APPLICATION

The present application is claiming priority of Korean Patent Application No. 10-2003-0097362, filed on Dec. 26, 2003, the content of which is incorporated herein by reference.

### BACKGROUND OF THE INVENTION

1. Field of the Invention

The present invention relates to a communication terminal equipped with a replaceable cover, and in particular to a communication terminal equipped with a replaceable cover and a method of changing themes of the communication terminal using the same.

2. Description of the Related Art

Typically, communication terminals have been continuously developed to meet various needs of the customers. Particularly, a replaceable cover is used to satisfy needs of design changes. Such a replaceable cover has a structure to be mounted and separated to and from the communication terminal. A user can change an appearance of the communication terminal according to one's taste by replacing and mounting a replaceable cover.

In addition, a memory card has been mounted to the communication terminal to change display registration information of the communication terminal for various themes (for example, background screen, bell sound, effect sound, music data, menu, icon, screen, animation, alarm sound, user interface, etc.) that a user wants.

However, since the memory card can be separated from the communication terminal only after the replaceable cover is separated from the communication terminal, there are inconveniences in replacing the memory card when changing the display registration information for themes that a user wants.

Additionally, according to the prior art, since the memory card and a connector are physically connected to each other, so that there is a problem in that the memory card is broken due to an excessive force applied to the memory card when the memory card is connected and separated to and from the connector.

In particular, the memory card is very thin and small, so that there is a problem in that it is difficult for users to hold the memory card stably when separating the memory card from the communication terminal.

### SUMMARY OF THE INVENTION

Accordingly, the present invention has been made to solve the above-mentioned problems occurring in the prior art. The object of the present invention is to provide a replaceable cover which can change themes as well as an appearance of a communication terminal and can easily connect and separate a memory card having display registration information to and from a connector of the communication terminal by just replacing the cover of the communication terminal.

In addition, the other object of the present invention is to provide a method of changing themes of a communication terminal, which can replace an appearance and themes of the communication terminal at the same time using a replaceable cover and can easily connect and separate a memory card having display registration information for the communication terminal to and from a connector of the communication terminal.

In order to accomplish the objects, there is provided a communication terminal equipped with a replaceable cover comprising a cover body; and a memory card, fixed to an inner surface of the cover body, for providing display registration information to the communication terminal, wherein the memory card is directly connected to a connector of the communication terminal when the cover is mounted to the communication terminal, and wherein themes of the communication terminal can be changed by replacing the cover according to the display registration information provided by the memory card.

Preferably, a plurality of terminals for signaling between the memory card and the connector of the communication terminal may be provided on one surface of the memory card to be in contact with the connector of the communication terminal.

Preferably, the cover body may comprise a front cover, a rear cover and a connecting member connecting the front cover and the rear cover, and the memory card may be fixed to an inner surface of the connecting member.

Preferably, the connecting member, the front cover and the rear cover may be integrated into one body.

Preferably, the cover body may be made of an elastic material.

Preferably, the memory card may be fixed to the cover body by being inserted into an insert recess formed in the inner surface of the cover body.

Preferably, the memory card may be fixed to the cover body by being adhered to the inner surface of the cover body with glue.

Preferably, replacing the replaceable cover results in a change of appearance of the communication terminal and a change of themes of the communication terminal at the same time.

In order to achieve the above objects, there is provided a method of changing themes of a communication terminal using a replaceable cover comprising: mounting a replaceable cover to which a memory card is fixed to a communication terminal, said memory card having display registration information; sensing the display registration information inputted in the memory card; reading the sensed display registration information; and changing themes of the communication terminal according to the read display registration information.

Preferably, the act of mounting the replaceable cover to the communication terminal may make the memory card and a connector of the communication terminal be in contact with each other directly.

Preferably, replacing the replaceable cover results in a change of appearance of the communication terminal and a change of themes of the communication terminal at the same time.

Preferably, the acts of sensing and reading the display registration information may be executed by the connector, a processor of the communication terminal may receive the display registration information read by the connector and the processor may change themes of the communication terminal in response to the display registration information.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view respectively illustrating a replaceable cover and a mobile communication terminal with the replaceable cover according to a preferred embodiment of the present invention;

FIG. 2 is an enlarged sectional view illustrating that the replaceable cover and the mobile communication terminal illustrated in FIG. 1 are combined;

FIG. 3 is an enlarged sectional view illustrating that a replaceable cover according to another embodiment of the invention and a mobile communication terminal are combined; and

FIG. 4 is a flow chart illustrating a method of changing themes of a communication terminal using a replaceable cover according to an embodiment of the invention.

### DETAILED DESCRIPTION OF THE PREFERRED EMBODIMENTS

Hereinafter, preferred embodiments of the present invention will be described with reference to the accompanying drawings. In the following description of the present invention, a detailed description of known functions and configurations incorporated herein will be omitted when it may make the subject matter of the present invention rather unclear.

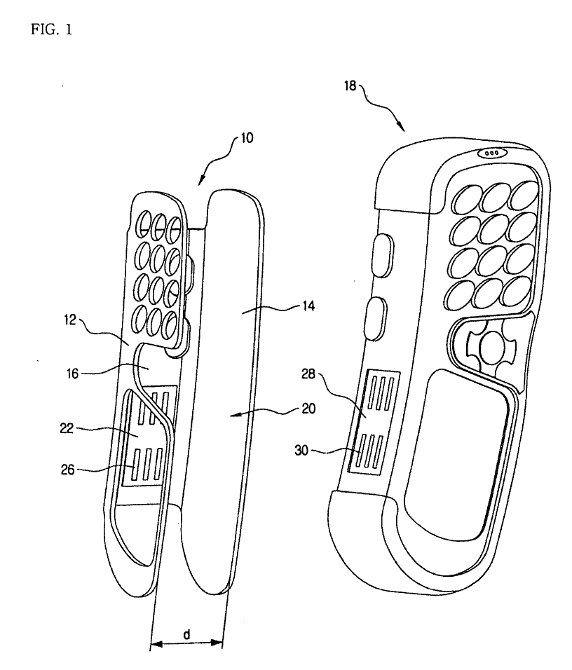

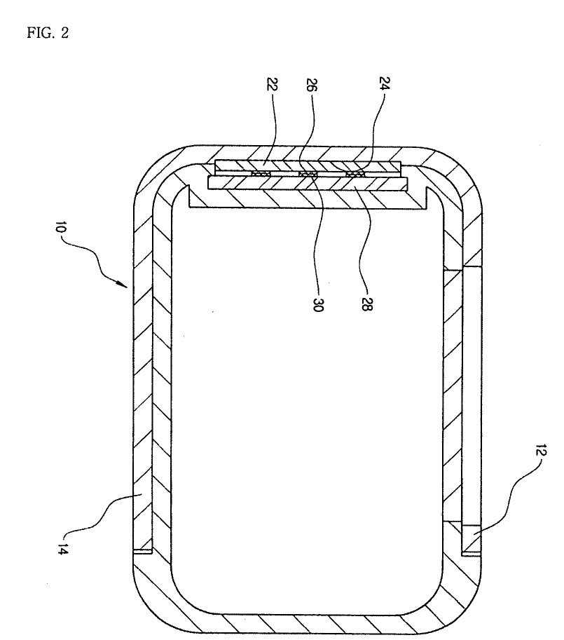

FIG. 1 is a perspective view respectively illustrating a replaceable cover and a mobile communication terminal with the replaceable cover according to a preferred embodiment of the present invention, and FIG. 2 is an enlarged sectional view illustrating that the replaceable cover and the mobile communication terminal illustrated in FIG. 1 are combined.

As illustrated in FIGS. 1 and 2, the replaceable cover 10 comprises a front cover 12, a rear cover 14 and a connecting member 16. A memory card 22 is mounted on an inner surface of the connecting member 16. Data capable of providing various themes to mobile communication terminal is installed in the memory card 22. The front cover 12, the rear cover 14 and the connecting member 16 constitute a cover body of the replaceable cover 10. The cover body 12, 14, 16 is preferably formed in one united body and may be made of an elastic material.

The front cover 12 and the rear cover 14 have a predetermined area and various shapes and they are separated from each other at an interval “d.” The connecting member 16 connects one side of the front cover 12 and one side of the rear cover 14 together, maintaining the interval “d.” A holding part 20 is formed between the front cover 12 and the rear cover 14 so that the holding part can hold a mobile communication terminal 18 with each side of the front cover and the rear cover. The mobile communication terminal 18 is entirely pushed into the replaceable cover 10 through the holding part 20 to be fully in contact with the replaceable cover 10. By doing so, the replaceable cover 10 is mounted to the mobile communication terminal 18.

An insert recess 24 is formed in the inner surface of the connecting member 16, so that a part of the memory card 22 is inserted into the insert recess 24 and thus fixed to the connecting member 16. In addition, a plurality of terminals 26 for signaling between the memory card and a connector of the mobile communication terminal are provided on one surface of the memory card 22.

The mobile communication terminal 18 comprises a connector 28 at a position corresponding to the memory card 22. The connector 28 has a plurality of terminals 30 that senses display registration information inputted in the memory card 22 when being in contact with the memory card 22.

As shown in FIGS. 1 and 2, users can replace the replaceable cover 10 and the memory card 22 at the same time by just replacing the cover 10. At this time, the memory card 22 is inserted in the insert recess 24 and thus fixed to the replaceable cover 10.

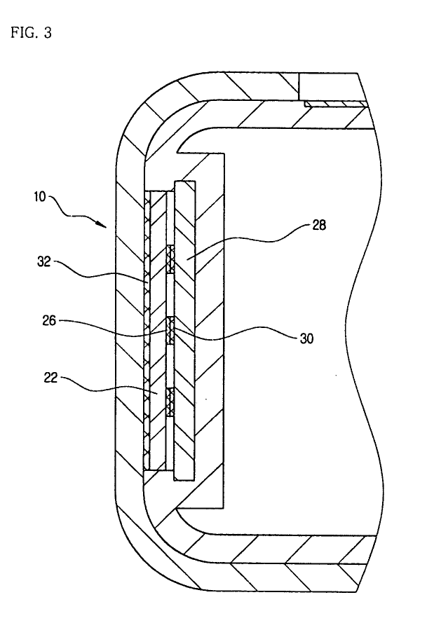

FIG. 3 is an enlarged sectional view illustrating that a replaceable cover according to another embodiment of the invention and a mobile communication terminal are combined. In FIG. 3, reference numerals used in FIG. 2 will be used to designate the same parts and overlapped explanations will be omitted.

As illustrated in FIG. 3, the memory card 22 is adhered to the connecting member 16 of the replaceable cover 10 by glue 32. Preferably, double sided tape, which is easily removable, may be used as the glue 32.

As with the replaceable cover illustrated in FIG. 2, a user can replace the replaceable cover 10 and the memory card 22 at the same time by just replacing the cover 10. At this time, as described above, the memory card 22 is adhered to the connecting member of the replaceable cover 10 by glue 32 and thus fixed to the replaceable cover 10.

The replaceable cover 10 is mounted to the mobile communication terminal 18 by pushing the mobile communication terminal 18 through the holding part 20 of the replaceable cover 10. Upon pushing the mobile communication terminal through the holding part 20 thoroughly, the terminals of the memory card 22 are in contact with terminals of the connector of the mobile communication terminal, signaling between the memory card 22 and the connector of the mobile communication terminal.

At the same time, the front cover 12 and the rear cover 14 of the replaceable cover 10 press the corresponding surfaces of the mobile communication terminal 18 with an elastic force, so that the combination of the replaceable cover 10 and the mobile communication terminal 18 is completed.

In particular, the memory card 22 of the replaceable cover 10 can provide different display registration information according to themes to be provided by the replaceable cover. Accordingly, replacing the cover 10 gives user a change of appearance of the mobile communication terminal and a change of themes of the mobile communication terminal at the same time.

In addition, when the user separates the cover 10 from the mobile communication terminal to change the themes, the memory card 22 and the connector 28 are easily separated from each other because the memory card 22 and the connector 28 are in contact with each other without a special physical connecting structure.

Meanwhile, when the user wants to replace only the cover 10 while maintaining the themes provided by the memory card 22, the user can separate the mobile communication terminal 18 from the cover, unfolding the front cover 12 and the rear cover 14 of the replaceable cover 10 not to hold the mobile communication terminal any longer.

At that moment, since there is no physical connecting structure between the memory card 22 fixed to the replaceable cover 10 and the connector 28 of the mobile communication terminal 18, the memory card 22 is easily disconnected from the connector 28, upon trying to separate the replaceable cover 10 from the mobile communication terminal.

Then, after separating the memory card 22 from the replaceable cover 10, the memory card 22 is fixed to a new replaceable cover by using an insert recess of the replaceable cover or glue. Thereafter, the replaceable cover is mounted to the mobile communication terminal.

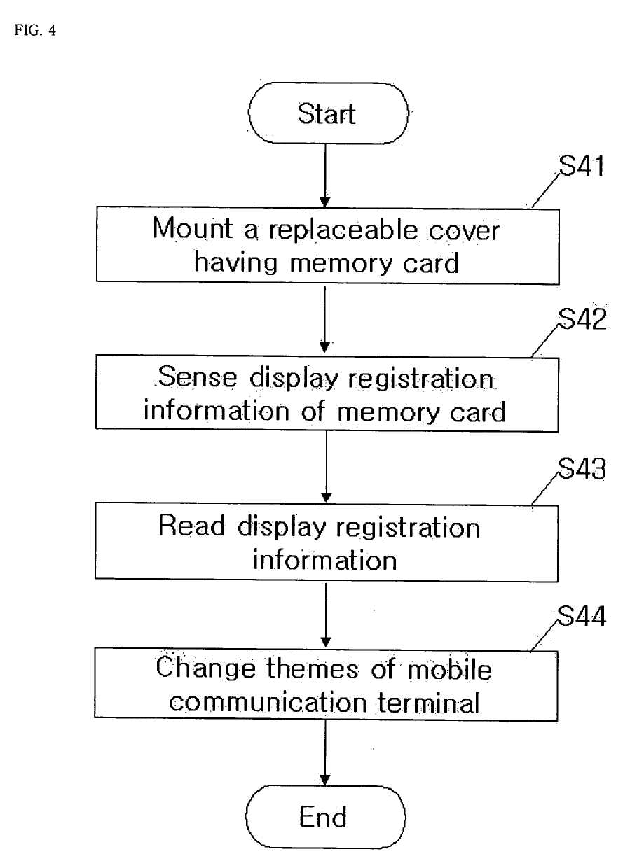

FIG. 4 is a flow chart illustrating a method of changing themes of a communication terminal using a replaceable cover according to an embodiment of the invention. With reference to FIGS. 1 and 4, a method of changing themes using a replaceable cover will be explained as follows.

When changing themes of the mobile communication terminal 18 using the replaceable cover 10, a replaceable cover is selected by a user and then mounted to the mobile communication terminal 18. For example, after the existing replaceable cover is separated from the mobile communication terminal 18 a new replaceable cover 10 having design that the user wants or a new replaceable cover 10 having a memory card providing themes that the user wants is mounted to the mobile communication terminal 18 (S41).

When the replaceable cover 10 is mounted to the mobile communication terminal 18 as described above, the connector 28 of the mobile communication terminal 18 is in contact with the memory card 22 and senses display registration information inputted in the memory card 22 (S42).

The display registration information is read by the connector 28 (S43) because the connector 28 for sensing the display registration information also has a function of reading the display registration information.

After that, the read display registration information is transmitted to a processor (not shown) in the mobile communication terminal 18. The processor changes themes of the mobile communication terminal 18 in response to the transmitted display registration information (S44).

As described above, according to the present invention, the themes of the mobile communication terminal can be changed by the replaceable cover while maintaining satisfaction provided by the replaceable cover giving a change of appearance of the mobile communication terminal.

In addition, since the memory card of the replaceable cover and the connector of the mobile communication terminal are connected without physical structure, it is possible to easily connect and disconnect the memory card and the connector and to improve an appearance of the mobile communication terminal.

While the invention has been shown and described with reference to certain preferred embodiments thereof, it will be understood by those skilled in the art that various changes in form and details may be made therein without departing from the spirit and scope of the invention as defined by the appended claims.

1. A communication terminal equipped with a replaceable cover comprising:
a cover body; and
a memory card, fixed to an inner surface of the cover body, for providing display registration information to the communication terminal,
wherein the memory card is directly connected to a connector of the communication terminal when the cover is mounted to the communication terminal, and wherein themes of the communication terminal can be changed by replacing the cover according to the display registration information provided by the memory card.

2. The communication terminal according to claim 1, wherein a plurality of terminals for signaling between the memory card and the connector of the communication terminal are provided on one surface of the memory card to be in contact with the connector of the communication terminal.

3. The communication terminal according to claim 1, wherein the cover body comprises a front cover, a rear cover and a connecting member connecting the front cover and the rear cover, and wherein the memory card is fixed to an inner surface of the connecting member.

4. The communication terminal according to claim 3, wherein the connecting member, the front cover and the rear cover are integrated into one body.

5. The communication terminal according to claim 1, wherein the cover body is made of an elastic material.

6. The communication terminal according to claim 1, wherein the memory card is fixed to the cover body by being inserted into an insert recess formed in the inner surface of the cover body.

7. The communication terminal according to claim 1, wherein the memory card is fixed to the cover body by being adhered to the inner surface of the cover body with glue.

8. The communication terminal according to claim 1, wherein replacing the replaceable cover results in a change of appearance of the communication terminal and a change of themes of the communication terminal at the same time.

9. A method of changing themes of a communication terminal using a replaceable cover comprising:
mounting a replaceable cover to which a memory card is fixed to the communication terminal, said memory card having display registration information;
sensing the display registration information inputted in the memory card;
reading the sensed display registration information; and
changing themes of the communication terminal according to the read display registration information.

10. The method according to claim 9, wherein the act of mounting the replaceable cover to the communication terminal makes the memory card and a connector of the communication terminal be in contact with each other directly.

11. The method according to claim 9, wherein replacing the replaceable cover results in a change of appearance of the communication terminal and a change of themes of the communication terminal at the same time.

12. The method according to claim 10, wherein the acts of sensing and reading the display registration information are executed by the connector, wherein a processor of the communication terminal receives the display registration information read by the connector and wherein the processor changes themes of the communication terminal in response to the display registration information.
